(19) United States
(12) Patent Application Publication
(10) Pub. No.: US 2009/0159194 A1
(43) Pub. Date: Jun. 25, 2009

(54) APPARATUS AND METHOD FOR PRINTING A WEB

(75) Inventors: Volker Brod, Bad Abbach (DE); Franz Rauch, Siegertsbrunn (DE); Ralf God, Dresden (DE)

Correspondence Address: BLACK LOWE & GRAHAM, PLLC, 701 FIFTH AVENUE, SUITE 4800, SEATTLE, WA, 98104, US

(73) Assignee: Muehlbauer AG, Roding (DE)

(21) Appl. No.: 12/329,300

(22) Filed: Dec. 5, 2008

Related U.S. Application Data
(62) Division of application No. 10/566,736, filed on Feb. 1, 2006.

(30) Foreign Application Priority Data
Aug. 1, 2003 (DE) 10336025.5

(51) Int. Cl. B32B 38/00; B29C 65/48; B23K 1/00; B23K 26/20; B23K 20/10

(52) U.S. Cl. 156/272.8; 156/60; 228/101; 219/121.64; 228/110.1; 156/272.2

(57) ABSTRACT

A device for printing at least one web that is driven continuously through said device, in addition to a method for printing said web. At least one unit is integrated into the device for the continuous transfer of individual transponders or transponder parts, which operate according to the radio frequency identification principle, from at least one continuous carrier belt to the web. During said process, the running speed of the carrier belt is adapted to the running speed of the web, the latter speed being predetermined by the printing process. A connection device connects the transponders or transponder parts to the web in a predetermined section of the carrier belt and the web, when the speeds have been synchronised.

### PRIORITY CLAIM

This application is a divisional of U.S. application Ser. No. 10/566,736 filed Feb. 1, 2006 which is a national phase application of PCT/EP04/008369 filed Jul. 27, 2004 which claims priority to German Application Serial No. 103 36 025.5 filed Aug. 1, 2003, contents of which are incorporated herein.

### FIELD OF THE INVENTION

The invention relates to an apparatus for printing at least one web running continuously through it and also to a method for printing the web running through the apparatus.

### BACKGROUND

Apparatuses for printing webs, in particular paper webs, are widely known. By way of example, DE 27 18 299 A1 discloses a printing machine in which, in order to print a continuously vertically running web with different colours, a plurality of printing plate cylinders and rubber blanket cylinders of different printing units are arranged to print the colours onto the preferably endlessly running paper web. Such printing machines are usually designed to apply only colours to the paper webs.

Such printing machines are also used to print passes and other cards, by means of which the owner of the card is to be identified. To date, in order to implement such identification processes, magnetic strips are applied for example to the rear side of cards made of paper, such as in the case of the known parking ticket, in order to make it possible for the owner of a previously parked vehicle to assign the paid parking fee to him and his vehicle and thus pass through the exit barrier of the car park. Such magnetic strip cards made of paper must be applied to the outer surface of the card in order to make it possible for the information contained in the magnetic strip to be read by a device into which the magnetic strip card has to be inserted.

Accordingly, such magnetic strip cards are sensitive to dirt, moisture and mechanical influences and have to be inserted into a reader in a predefined insertion direction since the magnetic strips have a predefined reading direction. Such readers must be found separately and thus delay the necessary data detection. Moreover, when they are invalidated, such magnetic strip cards have to be provided with data on the outside, so as to ensure that the data can be detected even if the magnetic strip is damaged.

Furthermore, the manufacture of magnetic strip cards as data-reading and/or data-writing cards is often carried out by means of printing machines which are preferred on account of their possible high manufacturing speeds and the high numbers of items that can be produced.

### SUMMARY

Accordingly, the object of the present invention is to provide an apparatus and a method for printing webs made of paper, plastic or other such materials, by means of which rapid production of printed cards in large numbers with integrated data-reading and/or data-writing devices is possible, said cards being insensitive to dirt and allowing rapid data exchange.

This object is achieved in terms of the apparatus by the features of claim 1 and in terms of the method by the features of claim 10.

One essential point of the invention is that integrated in an apparatus for printing at least one web running continuously through it is in addition a device for continuously transferring individual transponders or transponder parts, based on the functional principle of radio frequency identification, from at least one continuously running carrier belt to the web while matching a running speed of the carrier belt to a predefined running speed of the web, wherein the running speed is defined by means of a printing procedure. In this case, at a predefined section of the carrier belt and of the web, a bonding device bonds the transponders or transponder parts to the web at synchronized running speeds. By virtue of the continuous application and bonding of transponders or transponder parts to the web, that is to say without temporary stoppage of the web and/or of the carrier belt during this transfer operation, the situation is advantageously achieved, taking account of a synchronization of the running speed of the carrier belt and of the web, that the printing speeds of several hundred metres per minute in the case of conventional printing machines can also be maintained when integrating transponders or transponder parts.

Such transponders or transponder parts are based on the functional principle of radio frequency identification (RFID), which allows contactless and also optically contactless data exchange with a reading and/or writing device with high reading reliability and rapid data detection. In this way, for example, the separate insertion of a magnetic strip card into a reader provided for this purpose, which requires a lengthy procedure, is no longer necessary.

According to one preferred embodiment, the bonding device comprises at least one unit for producing soldered, adhesive, laser-welded and/or ultrasonic bonds. Such units must be designed to operate extremely rapidly and in a positionally accurate manner, in order to maintain synchronization of the running speeds of the carrier belt and of the web.

Moreover, the transfer device comprises at least one supply unit for supplying the transponders or transponder parts to the web by means of the carrier belt, wherein the supply unit consists inter alia of at least one unwinding roll, from which the carrier belt is unwound, and a speed regulating unit for synchronizing the running speeds of the carrier belt and of the web.

In addition, such a supply unit may comprise a wedge-shaped device along which the carrier belt slides until just before the surface of the web. In this case, the web-shaped device serves inter alia to deflect the carrier belt into a direction running counter to the running direction of the web, just before the start of the surface of the web, in order to move the carrier belt away from the location at which the individual transponders or transponder parts are applied to the web.

According to one preferred embodiment, the transfer device comprises units for measuring the running speeds of the carrier belt and of the web, so that advantageously the speeds can be matched to one another by means of an additional control device.

Preferably, the transfer device comprises a curing unit for curing the bonds by means of air, UV irradiation, laser irradiation, thermodes and/or electron beam irradiation, so that curing is possible even in the case of a high throughput of the apparatus.

A plurality of transfer devices can be positioned as desired in relation to the surface of the web, so that different transfer operations for fitting the web with different transponders or transponder parts at different positions can be carried out. By virtue of such an arrangement of a plurality of transfer devices, the multiple-lane simultaneous transfer of a plurality of transponders or transponder parts is also possible.

Examples of such transponders are smart labels, inlets, interposers, straps or bare dice. Examples of transponder parts are bridges or interposers, as are known for example as RFID modules.

In a method for printing at least one web made of paper, plastic or other such materials running continuously through an apparatus, the transponders or transponder parts are transferred from a carrier belt to the web by means of at least one transfer device, at a second speed of the carrier belt which is matched in a synchronous manner to a first speed of the web. In this case, in accordance with a principle contained in the transfer operation for mounting transponders or transponder parts on the web—also referred to as the substrate web—a predefined force is exerted on the transponder or the transponder part, which has already been applied to the web, at a predefined temperature by means of two rollers which encompass the web on its upper and lower side, this being preceded by a previously matched positioning of the transponders and in particular of the transponder parts at locations provided for this on the surface of the web. This relates in particular to the use of RFID modules as transponder parts which have to be matched in terms of their position to different spacings of terminal faces, such as antenna terminals for example, which may already be arranged on the substrate web.

Further embodiments emerge from the dependent claims.

### BRIEF DESCRIPTION OF THE DRAWINGS

Advantages and expedient developments can be found in the following description in conjunction with the drawing, in which:

FIG. 1 shows a schematic cross-sectional diagram of the apparatus of the invention according to a first embodiment of the invention;

FIG. 2 shows a schematic plan view of the apparatus of the invention according to the first embodiment;

FIG. 3 shows a schematic cross-sectional view of the apparatus of the invention;

FIG. 4 shows a schematic cross-sectional diagram of the apparatus of the invention according to a second embodiment of the invention;

FIG. 5 shows a schematic plan view of the apparatus of the invention according to the second embodiment, and

FIG. 6 shows a schematic diagram of part of the apparatus of the invention according to a third embodiment of the invention.

### DETAILED DESCRIPTION OF THE PREFERRED EMBODIMENT

FIG. 1 shows a schematic cross-sectional diagram of the apparatus of the invention according to a first embodiment. The apparatus 1 for printing webs 2 running continuously through it consists of a roll 3 for winding up the web and a roll 4 for unwinding the web. The web 2 is for example a paper web or a substrate web made of plastic material and has a running direction as shown by an arrow 5.

A carrier belt 8, the running direction of which is shown by an arrow 9, moves from an unwinding roll 6 to a wind-up roll 7 at a running speed which is synchronized with the running speed of the web 2.

Arranged on the carrier belt 8 are individual transponders which are applied to the web 2 by means of a bonding unit 11 in a continuous bonding process without any temporary stoppage of the carrier belt 8 or web 2. A bonding technique used for this purpose may be soldering, adhesive bonding, laser spot welding, laser welding or ultrasonic irradiation.

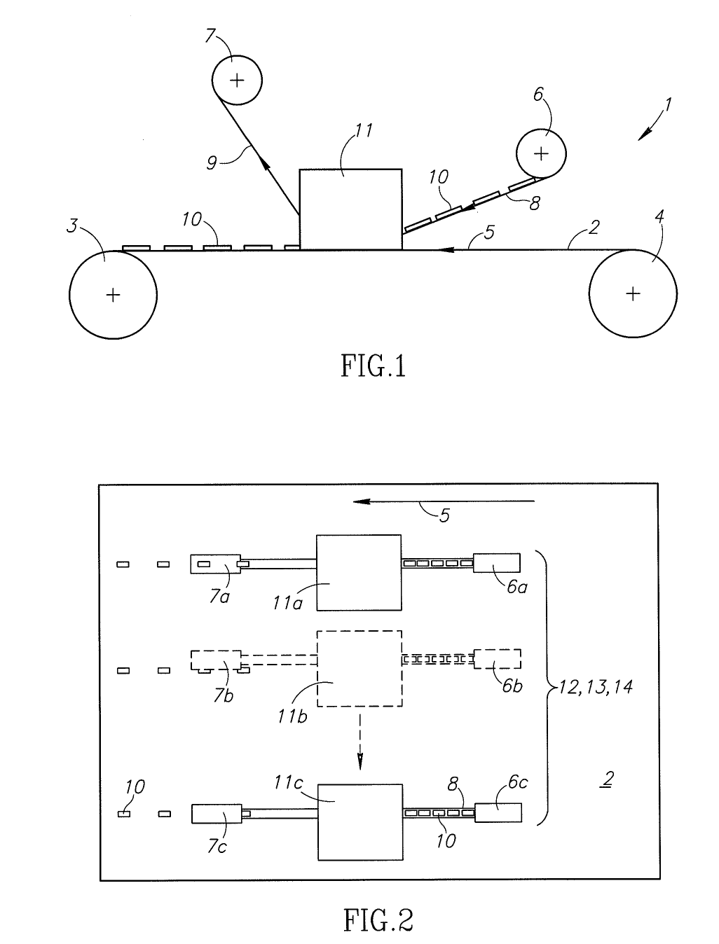

FIG. 2 shows a plan view of the apparatus of the invention according to the first embodiment of the invention. As can be seen from the diagram, arranged above the web 2 is a multiple-lane arrangement of a plurality of transfer devices 12, 13 and 14 for fitting the web with transponders in the individual fitting lanes. To this end, each transfer device has an unwinding unit 6a, 6b and 6c and a winding unit 7a, 7b and 7c. Within the bonding unit 11a, 11b and 11c, the transponders, such as smart label inlets 10 for example, are transferred from the carrier belt 8 to the web 2, on which they are arranged in lanes with the desired spacings after leaving the bonding units.

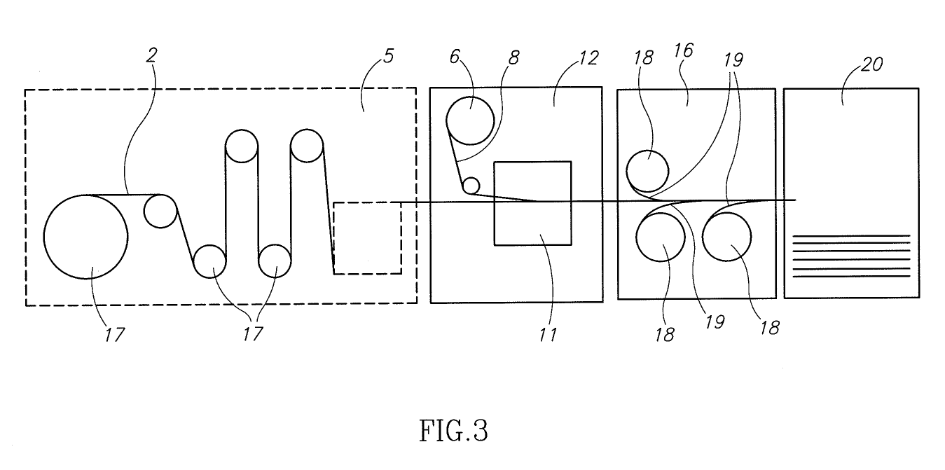

FIG. 3 shows a schematic side view of the apparatus of the invention. It can clearly be seen from this diagram that the web 2 runs around a plurality of rollers 17 arranged in a colour-printing unit 15, said rollers usually being arranged in conventional printing machines, before said web is fitted with transponders or transponder parts in the transfer device 12 in order then to be covered with laminating layers 19 in a downstream laminator unit 16, said laminating layers being unwound from unwinding units 18. A cutting operation then takes place, and the cut web portions are stacked in a section 20.

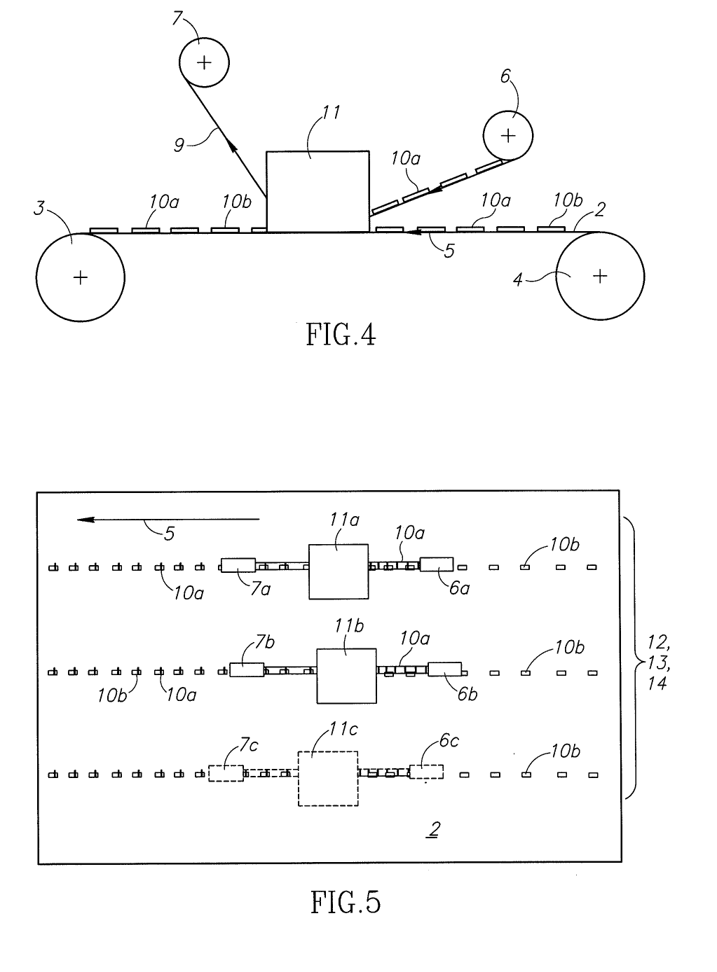

FIG. 4 shows a schematic cross-sectional view of the apparatus of the invention according to a second embodiment of the invention. This embodiment differs from the first embodiment shown in FIG. 1 in that, instead of entire transponder units 10, only transponder parts 10a such as bridges or interposers for example are transferred to the web 2. In this case, the transfer of individual transponder parts serves for example for the subsequent production of smart labels, wherein the web already has printed antennas 10b before the transponder parts are applied.

The transponder parts must be removed from the carrier belt and applied to the surface of the web in a precisely positioned manner so that they can form contacts with antenna terminals of the antennas 10b already printed on the web. After leaving the transfer device, functioning RFID transponders, such as smart label inlets for example, are then applied to the web in multiple lanes, as shown for example in a plan view in FIG. 5. To this end, use is made of a plurality of transfer devices 12, 13, 14.

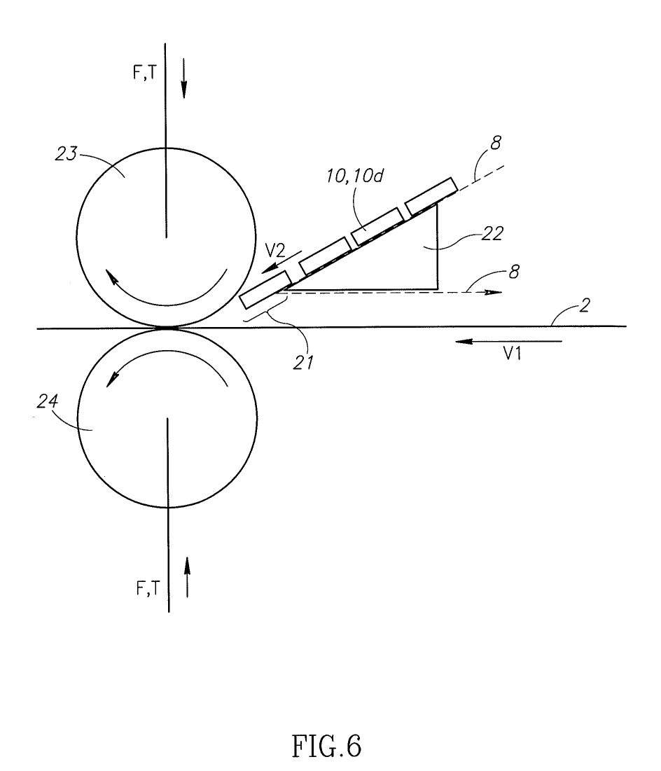

FIG. 6 shows part of a cross-sectional view of the apparatus of the invention according to a third embodiment of the invention. It can be seen from this FIG. 6 that, according to a mounting principle included in the transfer procedure, transponders or transponder parts are pressed onto the web 2 by means of two rollers 23, 24 with a predefined force F and at a predefined temperature T.

In this case, the carrier belt 8 (shown only indicatively) on which the transponders or transponder parts 10, 10a are arranged is deflected over a wedge-shaped device 22 and, following transfer of the individual transponders, runs in a direction opposite that of the running direction of the web 2, in order to allow the carrier belt 8 to run rapidly away from the bonding unit.

The transponder 10 or the transponder part 10a is supplied to the surface of the web 2 during the transfer operation via a section 21, in which the transponder 10 or the transponder part 10a temporarily moves in a freely floating manner almost without any support. Here, the web has a speed V1 and the carrier belt has a speed V2. On account of the use of a wedge-shaped device 22 and of the section 21, fixing and contacting of the individual transponders 10 or transponder parts 10a to the surface of the web within a short time is possible, so that the conventional speeds of a printing machine can be maintained.

All the features disclosed in the application documents are claimed as essential to the invention in so far as they are novel over the prior art individually or in combination.

1. A method for fitting at least one web material with one or more radio frequency identification transponder devices, the method comprising:
outputting the at least one web material at a predefined speed;
transporting the one or more transponder devices at the predefined speed; and
bonding the one or more transponder devices to the at least one web material at the predefined speed.

2. The method of claim 1, wherein bonding comprises producing at least one of a soldering bond, an adhesive bond, a laser-welded bond, or an ultrasonic bond.

3. The method of claim 1, wherein transporting includes supporting the one or more transponder devices on a belt, and supplying the one or more transponder devices from a supply unit to the belt.

4. The method of claim 3, wherein the supplying comprises unwinding the one or more transponder devices from a roll, measuring the speed of the carrier belt and the first device, and synchronizing the speed of the carrier belt with the speed of the first device.

5. The method according to claim 1, wherein bonding comprises curing bonds between the one or more transponder devices and the at least one web material according to at least one of air, UV irradiation, laser irradiation, thermodes or electron beam irradiation.

6. The method of claim 1, wherein transporting comprises transporting on a plurality of carrier belts and providing bonding with each of the plurality of carrier belts.

7. The method according to claim 6, wherein bonding comprises perform two or more different methods of fitting the transponder devices to the at least one web material.

8. The method of claim 1, wherein bonding includes passing the transponder devices and the at least one web material between two rollers, the rollers rotating counter to each other.

9. The method of claim 8, wherein transporting comprises changing the running direction of the belt to a direction approximately opposite to the running direction of the at least one web material and releasing each of the transponder devices at the point of direction change of the belt.
